(19) United States
(12) Patent Application Publication
(10) Pub. No.: US 2013/0098013 A1
(43) Pub. Date: Apr. 25, 2013

(54) CLOSED-LOOP SYSTEM HAVING MULTI-CIRCUIT FLOW SHARING

(71) Applicants: Brad A. EDLER, Waterloo, IL (US); Jeffrey L. Kuehn, Metamora, IL (US); Jeremy T. Peterson, Washington, IL (US); Michael T. Verkuilen, Metamora, IL (US)

(72) Inventors: Brad A. EDLER, Waterloo, IL (US); Jeffrey L. Kuehn, Metamora, IL (US); Jeremy T. Peterson, Washington, IL (US); Michael T. Verkuilen, Metamora, IL (US)

(21) Appl. No.: 13/278,745

(22) Filed: Oct. 21, 2011

(51) Int. Cl. F15B 11/17

(52) U.S. Cl. 60/327; 60/420

(57) ABSTRACT

A hydraulic system is disclosed. The hydraulic system may have a plurality of pumps with unidirectional functionality and being variable displacement, a common discharge passage connected to the plurality of pumps, and a common intake passage connected to the plurality of pumps. The hydraulic system may also have at least one actuator connected in closed-loop manner to the common discharge and common intake passages, and a switching valve associated with the at least one actuator and disposed between the at least one actuator and the common discharge and intake passages. The hydraulic system may additionally have at least one isolation valve configured to selectively isolate a portion of the common discharge passage and a portion of the common intake passage associated with one pump of the plurality of pumps from another pump of the plurality of pumps.

### TECHNICAL FIELD

The present disclosure relates generally to a hydraulic system and, more particularly, to a closed-loop hydraulic system having flow sharing between multiple circuits.

### BACKGROUND

A conventional open-loop hydraulic system includes a pump that draws low-pressure fluid from a tank, pressurizes the fluid, and makes the pressurized fluid available to multiple different actuators for use in moving the actuators. In this arrangement, a speed of each actuator can be independently controlled by selectively throttling (i.e., restricting) a flow of the pressurized fluid from the pump into each actuator. For example, to move a particular actuator at a high speed, the flow of fluid from the pump into the actuator is restricted by only a small amount. In contrast, to move the same or another actuator at a low speed, the restriction placed on the flow of fluid is increased. Although adequate for many applications, the use of fluid restriction to control actuator speed can result in flow losses that reduce an overall efficiency of a hydraulic system.

An alternative type of hydraulic system is known as a closed-loop hydraulic system. A closed-loop hydraulic system generally includes a pump connected in closed-loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator with a lower speed, the pump discharges the fluid at a slower rate. A closed-loop hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and little or no throttling of a fluid flow is required.

An exemplary closed-loop hydraulic system is disclosed in U.S. Pat. No. 4,369,625 of Izumi et al. that published on Jan. 25, 1983 (the '625 patent). In the '625 patent, a multi-actuator closed-loop hydraulic system is described that has flow combining functionality. The hydraulic system includes a swing circuit, a boom circuit, a stick circuit, a bucket circuit, a left travel circuit, and a right travel circuit. Each of the swing, boom, stick, and bucket circuits have a pump connected to a specialized actuator in a closed-loop manner. In addition, a first combining valve is connected between the swing and stick circuits, a second combining valve is connected between the stick and boom circuits, and a third combining valve is connected between the bucket and boom circuits. The left and right travel circuits are connected in parallel to the pumps of the bucket and boom circuits, respectively. In this configuration, any one actuator can receive pressurized fluid from more than one pump such that its speed is not limited by the capacity of a single pump.

Although an improvement over existing meterless hydraulic systems, the meterless hydraulic system of the '625 patent described above may still be less than optimal. In particular, operation of connected circuits of the system may only be sequentially performed. In addition, because of the connection locations of the pumps relative to the actuators and various control valves of the actuators (i.e., because the flows only combine at locations between the control valves and the respective actuators) the speeds and/or forces of the various actuators may be difficult to control during flow combining.

The hydraulic system of the present disclosure is directed toward solving one or more of the problems set forth above and/or other problems of the prior art.

### SUMMARY

In one aspect, the present disclosure is directed to a hydraulic system. The hydraulic system may include a plurality of pumps having unidirectional functionality and being variable displacement, a common discharge passage connected to the plurality of pumps, and a common intake passage connected to the plurality of pumps. The hydraulic system may also include at least one actuator connected in closed-loop manner to the common discharge and common intake passages, and a switching valve associated with the at least one actuator and disposed between the at least one actuator and the common discharge and intake passages. The hydraulic system may additionally include at least one isolation valve configured to selectively isolate a portion of the common discharge passage and a portion of the common intake passage associated with one pump of the plurality of pumps from another pump of the plurality of pumps.

In another aspect, the present disclosure is directed to a method of operating a hydraulic system. The method may include pressurizing fluid with a plurality of pumps, and directing a combined flow of pressurized fluid from the plurality of pumps through at least one actuator and back to the plurality of pumps in closed-loop manner. The method may also include selectively switching a direction of the combined flow through the at least one actuator, and selectively isolating one pump of the plurality of pumps from another pump of the plurality of pumps.

### BRIEF DESCRIPTION OF THE DRAWINGS

FIG. 1 is a pictorial illustration of an exemplary disclosed machine; and

FIG. 2 is a schematic illustration of an exemplary disclosed hydraulic system that may be used in conjunction with the machine of FIG. 1.

### DETAILED DESCRIPTION

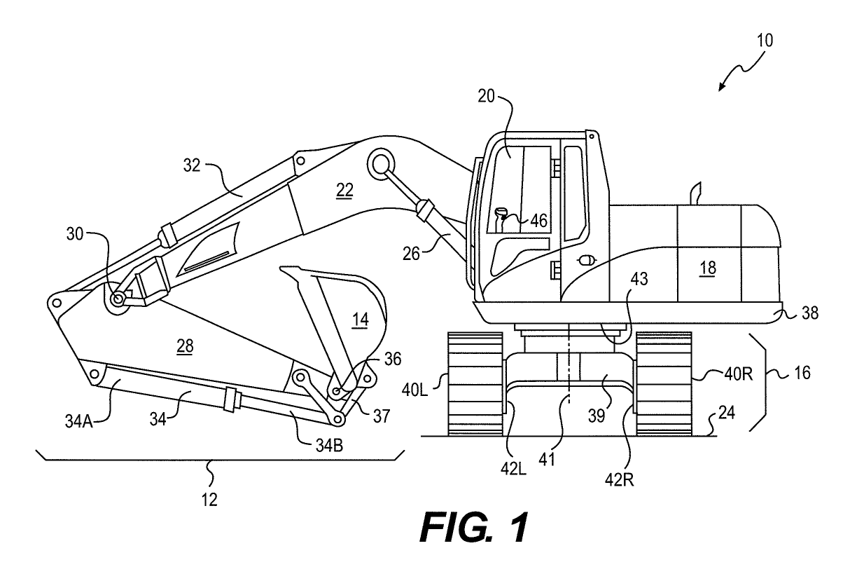

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dozer, a loader, a backhoe, a motor grader, a dump truck, or another earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by linear and rotary fluid actuators to move work tool 14. For example, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected at a head-end 34A to a portion of stick 28 and at an opposing rod-end 34B to work tool 14 by way of a power link 37. Boom 22 may be pivotally connected at a base end to a body 38 of machine 10. Body 38 may be connected to an undercarriage 39 and caused to swing about a vertical axis 41 by a hydraulic swing motor 43. Stick 28 may pivotally connect a distal end of boom 22 to work tool 14 by way of axes 30 and 36.

Numerous different work tools 14 may be attachable to a single machine 10 and operator controllable. Work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction about pivot axis 41, work tool 14 may alternatively or additionally rotate relative to stick 28, slide, open and close, or move in any other manner known in the art.

Drive system 16 may include one or more traction devices powered to propel machine 10. In the disclosed example, drive system 16 includes a left track 40L located on one side of machine 10, and a right track 40R located on an opposing side of machine 10. Left track 40L may be driven by a left travel motor 42L, while right track 40R may be driven by a right travel motor 42R. It is contemplated that drive system 16 could alternatively include traction devices other than tracks, such as wheels, belts, or other known traction devices. Machine 10 may be steered by generating a speed and/or rotational direction difference between left and right travel motors 42L, 42R, while straight travel may be facilitated by generating substantially equal output speeds and rotational directions of left and right travel motors 42L, 42R.

Power source 18 may embody an engine such as, for example, a diesel engine, a gasoline engine, a gaseous fuel-powered engine, or another type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving the linear and rotary actuators of implement system 12.

Operator station 20 may include devices that receive input from a machine operator indicative of desired maneuvering. Specifically, operator station 20 may include one or more operator interface devices 46, for example a joystick (shown in FIG. 1), a steering wheel, or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

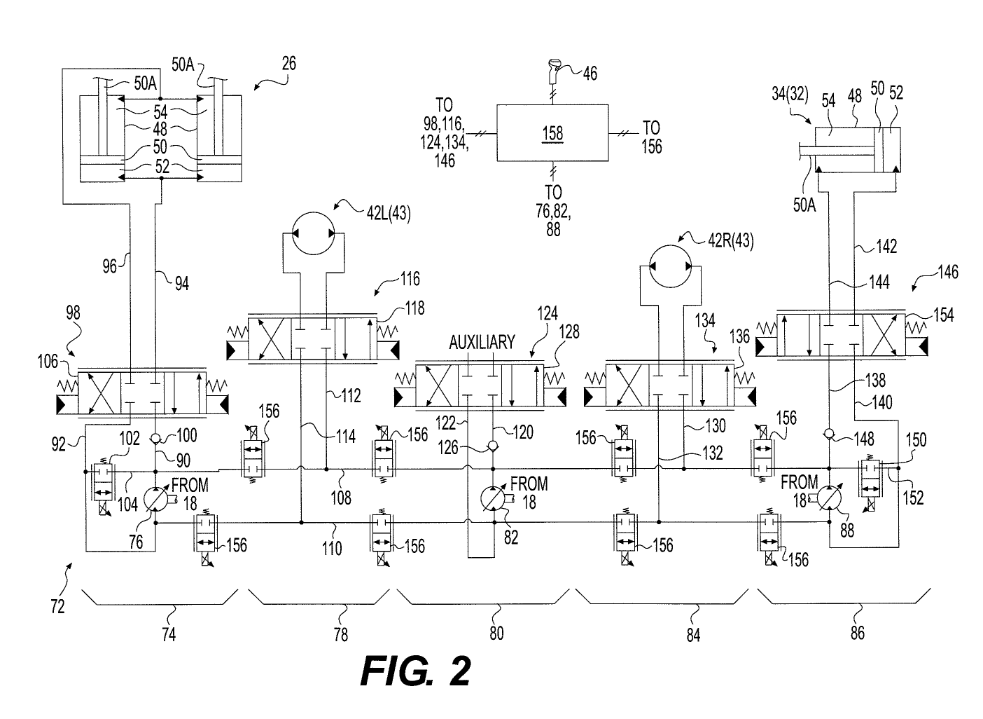

Four exemplary hydraulic actuators are shown in the schematic of FIG. 2. It should be noted that, while only four hydraulic actuators are shown, the depicted actuators may represent any one or more of the linear actuators (e.g., hydraulic cylinders 26, 32, 34) or the rotary actuators (left travel, right travel, or swing motors 42L, 42R, 43) of machine 10.

The hydraulic actuators, if embodied as linear actuators, may each include a tube 48 and a piston assembly 50 arranged within tube 48 to form a first chamber 52 and an opposing second chamber 54. In one example, a rod portion 50A of piston assembly 50 may extend through an end of second chamber 54. As such, each second chamber 54 may be considered the rod-end chamber of the respective actuator, while each first chamber 52 may be considered the head-end chamber. First and second chambers 52, 54 of each hydraulic actuator may be selectively supplied with pressurized fluid from one or more pumps and drained of the pressurized fluid to cause piston assembly 50 to displace within tube 48, thereby changing the effective length of the actuator to move work tool 14. A flow rate of fluid into and out of first and second chambers 52, 54 may relate to a translational velocity of each actuator, while a pressure differential between first and second chambers 52, 54 may relate to a force imparted by each actuator on work tool 14.

The hydraulic actuators, if embodied as rotary actuators, may function in a similar manner. That is, each rotary actuator may also include first and second chambers located to either side of a pumping mechanism such as an impeller, plunger, or series of pistons. When the first chamber is filled with pressurized fluid from one or more pumps and the second chamber is simultaneously drained of fluid, the pumping mechanism may be urged to rotate in a first direction by a pressure differential across the pumping mechanism. Conversely, when the first chamber is drained of fluid and the second chamber is simultaneously filled with pressurized fluid, the pumping mechanism may be urged to rotate in an opposite direction by the pressure differential. The flow rate of fluid into and out of the first and second chambers may determine a rotational velocity of each actuator, while a magnitude of the pressure differential across the pumping mechanism may determine an output torque. The rotary actuators could be fixed- or variable-displacement type motors, as desired.

Machine 10 may include a hydraulic system 72 having a plurality of fluid components that cooperate with the hydraulic actuators to move work tool 14 and machine 10. In particular, hydraulic system 72 may include, among other things, a closed-loop first circuit 74 fluidly connecting a first pump 76 with a first hydraulic actuator (e.g., hydraulic cylinders 26 associated with movement of boom 22) of machine 10, a closed-loop second circuit 78 associated with a second hydraulic actuator (e.g., left-travel or swing motors 42L, 43), a closed-loop third circuit 80 selectively connecting a second pump 82 with an auxiliary device such as a hydraulic actuator or tool (not shown), a closed-loop fourth circuit 84 associated with a third hydraulic actuator (e.g, right-travel or swing motors 42R, 43), and a closed-loop fifth circuit 86 fluidly connecting a third pump 88 with a fourth hydraulic actuator (e.g., hydraulic cylinder 32 associated with movement of stick 28). It is contemplated that hydraulic system 72 may include additional and/or different circuits or components, if desired, such as a charge circuit having one or more makeup valves, relief valves, pressure sources, and/or storage devices; pressure-compensating valves; and other circuits or valves known in the art.

First circuit 74 may include multiple different passages that fluidly connect first pump 76 to the first hydraulic actuator and, in some configurations, to the other actuators of machine 10 in a parallel, closed-loop manner. For example, first pump 76 may be connected to the first hydraulic actuator via a discharge passage 90, an intake passage 92, a head-end passage 94, and a rod-end passage 96. A first switching valve 98 may be disposed between discharge and intake passages 90, 92 and head- and rod-end passages 94, 96 to control fluid flow direction through first circuit 74. A first check valve 100 may be disposed within discharge passage 90 to help ensure a unidirectional flow of fluid through first pump 76. A first regeneration valve 102 may be disposed within a bypass passage 104 extending between discharge and intake passages 90, 92 to help regulate regeneration of fluid between first and second chambers 52, 54 of the first hydraulic actuator. In the disclosed embodiment, the connection of bypass passage 104 to discharge passage 90 may be located upstream of first check valve 100.

First switching valve 98 may include a pilot-operated spool element 106 movable between three positions. When spool element 106 is in the first position (right-most position shown in FIG. 2), discharge passage 90 may be fluidly connected with head-end passage 94, while intake passage 92 may be fluidly connected with rod-end passage 96 such that fluid from first pump 76 flows through the first hydraulic actuator in a first direction causing the first hydraulic actuator to move in a first direction (e.g., in an extending direction that lifts boom 22). When spool element 106 is in the second position (middle position shown in FIG. 2), discharge and intake passages 90, 92 may be substantially isolated from head- and rod-end passages 94, 96, such that the first hydraulic actuator may be inhibited from movement. When spool element 106 is in the third position (left-most position shown in FIG. 2), discharge passage 90 may be fluidly connected with rod-end passage 96, while intake passage 92 may be fluidly connected with head-end passage 94 such that fluid from first pump 76 flows through the first hydraulic actuator in a second direction opposite the first direction causing the first hydraulic actuator to move in a second direction (e.g., in a retracting direction that lowers boom 22).

Spool element 106 may be spring-biased to the second position and pilot-operated to move to any position between the first, second, and third positions, such that a desired amount of fluid from first pump 76 may flow through the first hydraulic actuator in a particular direction. Typically, spool element 106 will be in one of the first, second, and third positions during normal operations, and only move to an in-between position (i.e., a position between the first and second positions or between the second and third positions) when flows from different circuits are being combined and/or multiple actuators are simultaneously sharing pressurized fluid from a single or combined source.

First regeneration valve 102 may be solenoid-operated to move to any position between a flow-passing first position and a flow-blocking second position (shown in FIG. 2) such that a flow of fluid from first chamber 52 directly into second chamber 54 or vice versa may be facilitated and regulated. In particular, when first regeneration valve 102 is in the flow-passing position, pressurized fluid from one of first and second chambers 52, may be allowed to bypass first pump 76 and flow directly into the other first and second chambers 52, 54 via bypass passage 104. By allowing fluid from one chamber of a hydraulic actuator to bypass the associated pump and directly enter another chamber of the same actuator, the speed of the actuator and/or an efficiency of the associated system may be increased. When first regeneration valve 102 is moved to a position between the first and second positions, only some of the fluid from one chamber may be directly passed to the other chamber, while the remaining fluid may pass through first pump 76 in the conventional manner, thereby providing for enhanced control of the flow rate of fluid bypassing first pump 76 (and enhanced control of speed and/or force of the associated actuator during regeneration). First regeneration valve 102 may be spring-biased toward the flow-blocking position.

Second circuit 78 may include multiple different passages that fluidly connect the second hydraulic actuator to a source of pressurized fluid in a parallel, closed-loop manner. For example, the second hydraulic actuator may be connected to a common discharge passage 108 that extends between a high-pressure side of first, second, and third pumps 76, 82, and 88, and to a common intake passage 110 that extends between a low-pressure side of first, second, and third pumps 76, 82, and 88, via first and second actuator passages 112, 114, respectively. A second switching valve 116 may be disposed within first and second actuator passages 112, 114 to control a fluid flow direction through second circuit 78.

Second switching valve 116 may be substantially identical to first switching valve 98, and include a pilot-operated spool element 118 movable between three positions. When spool element 118 is in the first position (left-most position shown in FIG. 2), first actuator passage 112 may be fluidly connected with a first side of the second hydraulic actuator and second actuator passage 114 may be fluidly connected with a second side of the second hydraulic actuator, such that fluid from common discharge passage 108 flows through the second hydraulic actuator in a first direction causing the second hydraulic actuator to rotate in a first direction (e.g., in an forward traveling direction). When spool element 118 is in the second position (middle position shown in FIG. 2), fluid flow through the first and second actuator passages 112, 114 may be substantially blocked, such that movement of the second hydraulic actuator may be inhibited. When spool element 118 is in the third position (right-most position shown in FIG. 2), first actuator passage 112 may be fluidly connected with the second side of the second hydraulic actuator and second actuator passage 114 may be fluidly connected with the first side of the second hydraulic actuator, such that fluid from common discharge passage 108 flows through the second hydraulic actuator in a second direction causing the second hydraulic actuator to rotate in a second direction (e.g., in an rearward traveling direction). Spool element 118 may be substantially identical to spool element 106.

Third circuit 80 may include multiple different passages that fluidly connect the auxiliary device to second pump 82 in closed-loop manner. For example, the auxiliary device may be connected to second pump 82 via a discharge passage 120 and an intake passage 122. A third switching valve 124 may be disposed within discharge and intake passages 120, 122 to control a fluid flow direction through third circuit 80 and through the auxiliary device. A second check valve 126 may be disposed within discharge passage 120 to help ensure a unidirectional flow of fluid through second pump 82.

Third switching valve 124 may be substantially identical to first and second switching valves 98, 116, and include a pilot-operated spool element 128 movable between three positions. When spool element 128 is in the first position (left-most position shown in FIG. 2), discharge passage 120 may be fluidly connected with a first side of the auxiliary device and intake passage 122 may be fluidly connected with a second side of the auxiliary device, such that fluid from third pump 88 flows through the auxiliary device in a first direction. When spool element 128 is in the second position (middle position shown in FIG. 2), fluid flow through the auxiliary device may be substantially blocked. When spool element 128 is in the third position (right-most position shown in FIG. 2), discharge passage 120 may be fluidly connected with the second side of the auxiliary device and intake passage 122 may be fluidly connected with the first side of the auxiliary device, such that fluid from third pump 88 flows through the auxiliary device in a second direction. Spool element 128 may be substantially identical to spool elements 106 and 118.

Fourth circuit 84 may include multiple different passages that fluidly connect the third hydraulic actuator to a source of pressurized fluid in a parallel, closed-loop manner. For example, the third hydraulic actuator may be connected to common discharge passage 108 and to a common intake passage 110 via first and second actuator passages 130, 132, respectively. A fourth switching valve 134 may be disposed within first and second actuator passages 130, 132 to control a fluid flow direction through fourth circuit 84.

Fourth switching valve 134 may be substantially identical to first, second, and third switching valves 98, 116, 124, and include a pilot-operated spool element 136 movable between three positions. When spool element 136 is in the first position (left-most position shown in FIG. 2), first actuator passage 130 may be fluidly connected with a first side of the third hydraulic actuator and second actuator passage 132 may be fluidly connected with a second side of the third hydraulic actuator, such that fluid from common discharge passage 108 flows through the third hydraulic actuator in a first direction causing the third hydraulic actuator to rotate in a first direction (e.g., in an forward traveling direction). When spool element 136 is in the second position (middle position shown in FIG. 2), fluid flow through the first and second actuator passages 130, 132 may be substantially blocked, such that movement of the third hydraulic actuator may be inhibited. When spool element 136 is in the third position (right-most position shown in FIG. 2), first actuator passage 130 may be fluidly connected with the second side of the third hydraulic actuator and second actuator passage 132 may be fluidly connected with the first side of the third hydraulic actuator, such that fluid from common discharge passage 108 flows through the third hydraulic actuator in a second direction causing the third hydraulic actuator to rotate in a second direction (e.g., in an rearward traveling direction). Spool element 136 may be substantially identical to spool elements 106, 118, and 128.

Fifth circuit 86 may include multiple different passages that fluidly connect third pump 88 to the fourth hydraulic actuator and, in some configurations, to the other actuators of machine 10 in a parallel, closed-loop manner. For example, third pump 88 may be connected to the fourth hydraulic actuator via a discharge passage 138, an intake passage 140, a head-end passage 142, and a rod-end passage 144. A fifth switching valve 146 may be disposed between discharge and intake passages 138, 140 and head- and rod-end passages 142, 144 to control fluid flow direction through fourth circuit 86. A third check valve 148 may be disposed within discharge passage 138 to help ensure a unidirectional flow of fluid through third pump 88. A second regeneration valve 150 may be disposed within a bypass passage 152 extending between discharge and intake passages 138, 140 to help regulate regeneration of fluid between first and second chambers 52, 54 of the fourth hydraulic actuator. In the disclosed embodiment, the connection of bypass passage 152 to discharge passage 138 may be located upstream of third check valve 148.

Fifth switching valve 146 may include a pilot-operated spool element 154 movable between three positions. When spool element 154 is in the first position (right-most position shown in FIG. 2), discharge passage 138 may be fluidly connected with head-end passage 142, while intake passage 140 may be fluidly connected with rod-end passage 144 such that fluid from third pump 88 flows through the fourth hydraulic actuator in a first direction causing the fourth hydraulic actuator to move in a first direction (e.g., in an extending direction that lifts stick 28). When spool element 154 is in the second position (middle position shown in FIG. 2), discharge and intake passages 138, 140 may be substantially isolated from head- and rod-end passages 142, 144, such that the fourth hydraulic actuator is substantially inhibited from movement. When spool element 154 is in the third position (left-most position shown in FIG. 2), discharge passage 130 may be fluidly connected with rod-end passage 144, while intake passage 140 may be fluidly connected with head-end passage 142 such that fluid from third pump 88 flows through the fourth hydraulic actuator in a second direction opposite the first direction causing the fourth hydraulic actuator to move in a second direction (e.g., in a retracting direction that lowers stick 28). Spool element 154 may be substantially identical to spool elements 106, 118, 128, and 136.

Second regeneration valve 150 may be solenoid-operated to move to any position between a flow-passing first position and a flow-blocking second position (shown in FIG. 2) such that a flow of fluid from first chamber 52 directly into second chamber 54 or vice versa may be facilitated and regulated. In particular, when second regeneration valve 150 is in the flow-passing position, pressurized fluid from one of first and second chambers 52, may be allowed to bypass third pump 88 and flow directly into the other first and second chambers 52, 54 via bypass passage 152. When second regeneration valve 150 is moved to a position between the first and second positions, only some of the fluid from one chamber may be directly passed to the other chamber, while the remaining fluid may pass through first pump 76 in the conventional manner, thereby providing for enhanced control of the flow rate of fluid bypassing third pump 88 (and enhanced control of speed and/or force of the associated actuator during regeneration). Second regeneration valve 150 may be spring-biased toward the flow-blocking position.

First, second, and third pumps 76, 82, 88 may each be substantially identical variable-displacement type pumps that are controlled to draw fluid from the actuators of machine 10 and discharge the fluid at a specified elevated pressure back to the actuators in a single direction (i.e., pumps 76,82, 88 may be unidirectional pumps). Pumps 76, 82, 88 may each include a stroke-adjusting mechanism, for example a swashplate, a position of which is hydro-mechanically adjusted based on, among other things, a desired speed of the actuators to thereby vary an output (e.g., a discharge rate). The displacement of pumps 76, 82, 88 may be adjusted from a zero displacement position at which substantially no fluid is discharged, to a maximum displacement position at which fluid is discharged at a maximum rate into discharge passages 90, 120, 138, respectively. Pumps 76, 82, 88 may be drivably connected to power source 18 of machine 10 by, for example, a countershaft, a belt, or in another suitable manner. Alternatively, pumps 76, 82, 88 may be indirectly connected to power source 18 via a torque converter, a gear box, an electrical circuit, or in any other manner known in the art. It is contemplated that pumps 76, 82, 88 may be connected to power source 18 in tandem (e.g., via the same shaft) or in parallel (e.g., via a gear train), as desired. It should be noted that, although three pumps are included in the depicted embodiment, it is contemplated that additional or fewer pumps may be included, as desired.

Each actuator and each pump of hydraulic system 72 may be selectively isolated from each other via a plurality of isolation valves 156 disposed within common discharge and intake passages 108, 110. Each isolation valve 156 may be configured to move between a flow-passing position and a flow-blocking position (shown in FIG. 2). In the embodiment of FIG. 2, isolation valves 156 may be solenoid-operated toward the flow-passing position, and spring-biased toward the flow-blocking position. It is contemplated that, in some embodiments, isolation valves 156 may be selectively moved to any position between the flow-passing and flow-blocking positions, if desired.

During operation of machine 10, the operator may utilize interface device 46 to provide a signal that identifies a desired movement of the various linear and/or rotary actuators to a controller 158. Based upon one or more signals, including the signal from interface device 46 and, for example, signals from various pressure sensors (not shown) and/or position sensors (not shown) located throughout hydraulic system 72, controller 158 may command movement of the different valves and/or displacement changes of the different pumps to advance a particular one or more of the linear and/or rotary actuators to a desired position in a desired manner (e.g., at a desired speed and/or with a desired force).

Controller 158 may embody a single microprocessor or multiple microprocessors that include components for controlling operations of hydraulic system 72 based on input from an operator of machine 10 and based on sensed or other known operational parameters. Numerous commercially available microprocessors can be configured to perform the functions of controller 140. It should be appreciated that controller 158 could readily be embodied in a general machine microprocessor capable of controlling numerous machine functions. Controller 158 may include a memory, a secondary storage device, a processor, and any other components for running an application. Various other circuits may be associated with controller 158 such as power supply circuitry, signal conditioning circuitry, solenoid driver circuitry, and other types of circuitry.

### INDUSTRIAL APPLICABILITY

The disclosed hydraulic system may be applicable to any machine where improved hydraulic efficiency, performance, and control is desired. The disclosed hydraulic system may provide for improved efficiency through the selective use of closed-loop technology. Performance may be enhanced through unique structure that allow simultaneous operation of multiple actuators during flow-sharing and flow-combining operations. Control may be enhanced through simplified valve configurations. Operation of hydraulic system 72 will now be described.

During operation of machine 10, an operator located within station 20 may command a particular motion of work tool 14 in a desired direction and at a desired velocity by way of interface device 46. One or more corresponding signals generated by interface device 46 may be provided to controller 158 indicative of the desired motion, along with machine performance information, for example sensor data such as pressure data, position data, speed data, pump or motor displacement data, and other data known in the art.

For example, in response to the signals from interface device 46 indicative of a desire to lift boom 22, and based on the machine performance information, controller 158 may generate control signals directed to the stroke-adjusting mechanism of first pump 76 and/or to first switching valve 98. To drive the first hydraulic actuator (e.g., hydraulic cylinders 26) at an increasing speed in an extending direction (e.g., to raise boom 22), controller 158 may generate a control signal that causes first pump 76 of first circuit 74 to increase its displacement and discharge pressurized fluid into discharge passage 90 at a greater rate and/or a control signal that causes spool element 106 of first switching valve 98 to move toward its first position. As described above, when spool element 106 moves toward its first position, discharge passage 90 may be increasingly fluidly communicated with head-end passage 94 and rod-end passage 96 may be increasingly fluidly communicated with intake passage 92. When fluid from first pump 76 is directed into first chamber 52, return fluid from second chamber 54 of the first hydraulic actuator and/or from the other linear or rotary actuators of first circuit 74 may flow back into first pump 76 in closed-loop manner. Isolation valves 156 located between first and second circuits 74, 78 may be in their flow-blocking positions during normal extensions of the first hydraulic actuator. Extension of the fourth hydraulic actuator shown in FIG. 2 may be initiated in a similar manner.

To drive the first hydraulic actuator at an increasing speed in a retracting direction (e.g., to lower boom 22), controller 158 may generate a control signal that causes first pump 76 of first circuit 74 to increase its displacement and discharge pressurized fluid into discharge passage 90 at a greater rate and/or a control signal that causes spool element 106 of first switching valve 98 to move toward the third position. As described above, when spool element 106 moves toward the third position, discharge passage 90 may be increasingly fluidly communicated with rod-end passage 96 and head-end passage 94 may be increasingly fluidly communicated with intake passage 92. When fluid from first pump 76 is directed into second chamber 54, return fluid from first chamber 52 of the first hydraulic actuator and/or from the other linear or rotary actuators of first circuit 74 may flow back into first pump 76 in closed-loop manner. Isolation valves 156 located between first and second circuits 74, 78 may be in their flow-blocking positions during normal retractions of the first hydraulic actuator. Retraction of the fourth hydraulic actuator shown in FIG. 2 may be initiated in a similar manner.

During normal extensions of the first or fourth hydraulic actuators, more fluid may be required within the respective head-end passages 94, 142 than can be supplied by first and third pumps 76, 88 into first and second discharge passages 90, 138. That is, the respective rates of fluid flow into and out of the hydraulic actuators (if embodied as linear actuators) during extension and retraction may not be equal. In particular, because of the location of rod portion 50A within second chamber 54, piston assembly 50 may have a reduced pressure area within second chamber 54, as compared with a pressure area within first chamber 52. Accordingly, during retraction of the hydraulic actuators, more fluid may be forced out of first chamber 52 than can be consumed by second chamber 54 and, during extension, more hydraulic fluid may be consumed by first chamber 52 than is forced out of second chamber 54.

In order to accommodate the additional fluid required during extension of the first and/or fourth hydraulic actuators, the output of second pump 82 may be selectively directed into first and/or fifth circuits 74, 86. For example, during extension of the first hydraulic actuator shown in FIG. 2, controller 158 may generate a control signal that causes second pump 82 of third circuit 80 to increase its displacement and discharge pressurized fluid into common discharge passage 108 at a greater rate, and/or a control signal that causes the isolation valves 156 located between first and third circuits 74, 80 to move toward their flow-passing positions. When these isolation valves 156 move toward their flow-passing positions, common discharge passage 108 may be increasingly fluidly communicated with discharge passage 90 of first circuit 74, such that fluid flows from third circuit 80 into first circuit 74 at a greater rate. When fluid from third pump 88 is directed into first circuit 74, makeup fluid may be supplied to third pump 88 either from a charge circuit (not shown) or from fifth circuit 86 during retraction of the fourth actuator, as conditions allow.

In order to accommodate the excess fluid discharged from the first hydraulic actuator during retraction, at least a portion of the output of first pump 76 may be selectively directed into common discharge passage 108 for use by any of the other circuits of hydraulic system 72. The portion of the output of first pump 76 may be directed to any of the other circuits by selectively moving the appropriate isolation valves 156 to their flow-passing positions. This fluid entering common discharge passage 108, particularly if highly-pressurized (as may be the case during an overrunning condition), may help reduce the power consumption of second and/or third pumps 82, 88 and/or even be used to drive these pumps as motors to return energy back to power source 18. The discharge of excess fluid from fifth circuit 86 may function in a similar manner.

The second and third hydraulic actuators (e.g., left- and right-travel motors 42L, 42R) may be powered by any combination of first, second, and third pumps 76, 82, 88. In particular, because of the connection of these actuators to common discharge and intake passages 108, 110, the second and third hydraulic actuators may consume whatever fluid is provided to common discharge passage 108, and return fluid to common intake passage 110, regardless of which of first, second, and third pumps 76, 82, 88 are currently supplying fluid to and drawing fluid from common discharge and intake passages 108, 110.

Since the second and third hydraulic actuators, if embodied as left- and right-travel motors 42L, 42R (as shown in FIG. 2), may be primarily operable when the first and fourth hydraulic actuators are not being utilized (e.g., machine 10 may generally be traveling or moving work tool 14, but generally not traveling and moving work tool 14 at the same time), the second and third actuators may generally receive fluid pressurized by first pump 76 and third pump 88, respectively. That is, when the first hydraulic actuator is not being utilized by the operator of machine 10, first pump 76 may still pressurize fluid, but direct the pressurized fluid into common discharge passage 108 instead of into first circuit 74. The isolation valves 156 located between first and second circuits 74, 78 may be moved to their flow-passing positions at this time, such that the second hydraulic actuator may receive fluid from first pump 76 via common discharge passage 108 and return fluid to first pump 76 in closed-loop manner via common intake passage 110. If additional fluid is required to move the second hydraulic actuator at an operator-desired speed, second pump 82 may also be utilized to provide pressurized fluid into common discharge passage 108 and draw return fluid from common intake passage 110, with the isolation valves 156 located between second and third circuits 78, 80 being moved to their flow-passing positions. Although unlikely, additional fluid from third pump 86 may also be made available to the second hydraulic actuator in a similar manner. Likewise, second pump 82 and third pump 88, alone or in combination, may provide pressurized fluid to the second hydraulic actuator, as desired. Further, the third hydraulic actuator may receive pressurized fluid from any one or more of first, second, and third pumps 76, 82, and 88. Controller 156 may help to regulate the operation of each of the pumps, isolation valves, and switching valves during flow-sharing and flow-combining operations.

Metering of fluid flow rates into and/or out of the different actuators of hydraulic system 72 may generally only be required when fluid from different pumps is being combined and provided to a single actuator or when multiple actuators are simultaneously sharing fluid from a common source. In particular, when a single actuator is receiving fluid from a single pump, and that pump is only supplying fluid to the single actuator, the pump may be controlled to pressurize fluid at a flow rate associated with a demanded actuation speed of the single actuator. In this situation, the associated switching valves may be in one of the first and third positions and little or no metering of any fluid flows may be required. However, when a single pump simultaneously provides fluid to multiple actuators, the pump may be regulated by controller 158 to pressurize fluid at a rate that satisfies a total demand for fluid from all actuators. In this situation, the switching valves associated with each actuator may be moved to a position between the first and second or between the second and third positions, such that the flow rate of fluid into each actuator can be independently controlled. The switching valves may need to similarly meter combined fluid flows from multiple pumps, even if the combined flows are only being provided to a single actuator.

Because each pump in the disclosed hydraulic system may generally only provide pressurized fluid to a single actuator, the need to meter any fluid flows may low. Accordingly, the flows provided by the different pumps may be substantially unrestricted during most operations of the associated hydraulic actuators and significant energy may not be unnecessarily wasted in the actuation process. Thus, embodiments of the disclosure may provide improved energy usage and conservation. In addition, the closed-loop meterless operation of hydraulic system 72 may, in some applications, allow for a reduction or even complete elimination of metering valves for controlling fluid flow associated with the linear and rotary actuators. This reduction may result in a less complicated and/or less expensive system.

The disclosed hydraulic system may also allow for increased control over the different actuators. In particular, because flows from the different pumps may be combined upstream of the associated switching valves (and upstream of check valves 100, 126, 148), the switching valves may be selectively used to meter the combined flows without undesired shock loading caused by the actuators passing in reverse direction back to the pumps. This ability may enhance control over actuator velocity and/or force.

It will be apparent to those skilled in the art that various modifications and variations can be made to the disclosed hydraulic system. Other embodiments will be apparent to those skilled in the art from consideration of the specification and practice of the disclosed hydraulic system. For example, it is contemplated that switching valves 98, 116, 124, 134, and/or 146 may embody non-spool type valves and/or non-pilot operated types of valves, if desired. For example, direct solenoid operated valves having poppet-type elements may be utilized. It is intended that the specification and examples be considered as exemplary only, with a true scope being indicated by the following claims and their equivalents.

What is claimed is:

1. A hydraulic system, comprising:
a plurality of pumps having variable displacement functionality;
a common discharge passage connected to the plurality of pumps;
a common intake passage connected to the plurality of pumps;
at least one actuator connected in closed-loop manner to the common discharge and common intake passages;
at least one switching valve associated with the at least one actuator and disposed between the at least one actuator and the common discharge and intake passages; and
at least one isolation valve configured to selectively isolate a portion of the common discharge passage and a portion of the common intake passages associated with one pump of the plurality of pumps from another pump of the plurality of pumps.

2. The hydraulic system of claim 1, wherein:
the at least one actuator includes a plurality of actuators; and
the at least one switching valve includes a plurality of switching valves, one of the plurality of switching valves for each of the plurality of actuators.

3. The hydraulic system of claim 2, wherein a number of the plurality of actuators is greater than a number of the plurality of pumps.

4. The hydraulic system of claim 2, wherein the at least one isolation valve includes a plurality of isolation valves, each of the plurality of isolation valves being located between adjacent pumps of the plurality of pumps.

5. The hydraulic system of claim 4, wherein each of the plurality of isolation valves includes:
a first valve element associated with the common discharge passage; and
a second valve element associated with the common intake passage.

6. The hydraulic system of claim 2, wherein the plurality of actuators includes:
a left-travel motor;
a right travel motor; and
at least one linear actuator.

7. The hydraulic system of claim 6, wherein the at least one linear actuator includes a boom cylinder.

8. The hydraulic system of claim 7, further including a regeneration valve associated with at least one of the plurality of actuators, the regeneration valve configured to selectively connect the common discharge passage with the common intake passage at the at least one of the plurality of actuators.

9. The hydraulic system of claim 8, further including a plurality of check valves associated with the plurality of pumps, each of the plurality of check valves being disposed between the regeneration valve and the at least one of the plurality of actuators.

10. The hydraulic system of claim 9, wherein the regeneration valve is associated with the boom cylinder.

11. The hydraulic system of claim 2, wherein the plurality of pumps are unidirectional pumps.

12. The hydraulic system of claim 2, wherein each of the plurality of switching valves is a four-way valve configured to move between a first flow-passing position, a flow-blocking position, and a second flow-passing position.

13. The hydraulic system of claim 12, wherein each of the plurality of switching valves is spring-biased toward the flow-blocking position.

14. A hydraulic system, comprising:
a plurality of pumps having variable displacement and unidirectional functionality;
a common discharge passage connected to the plurality of pumps;
a common intake passage connected to the plurality of pumps;
a plurality of actuators connected in closed-loop manner to the common discharge and common intake passages, a number of the plurality of actuators being greater than a number of the plurality of pumps;
a plurality of switching valves associated with the plurality of actuators and disposed between the plurality of actuators and the common discharge and intake passages;
at least one isolation valve configured to selectively isolate a portion of the common discharge passage and a portion of the common intake passages associated with one pump of the plurality of pumps from another pump of the plurality of pumps;
a regeneration valve associated with at least one of the plurality of actuators, the regeneration valve configured to selectively connect the common discharge passage with the common intake passage at the at least one of the plurality of actuators; and
a plurality of check valves associated with the plurality of pumps, each of the plurality of check valves being disposed between the regeneration valve and the at least one of the plurality of actuators.

15. A method of operating a hydraulic system, comprising:
pressurizing fluid with a plurality of pumps;
directing a combined flow of pressurized fluid from the plurality of pumps through at least one actuator and back to the plurality of pumps in closed-loop manner;
selectively switching a direction of the combined flow through the at least one actuator; and
selectively isolating one pump of the plurality of pumps from another pump of the plurality of pumps.

16. The method of claim 15, wherein:
the at least one actuator includes a plurality of actuators; and
selectively switching a direction of the combined flow includes selectively switching a direction of the combined flow through the plurality of actuators.

17. The method of claim 16, wherein a number of the plurality of actuators is greater than a number of the plurality of pumps.

18. The method of claim 17, wherein selectively isolating one pump of the plurality of pumps from another pump of the plurality of pumps includes selectively isolating each pump from the plurality of pumps from all of the remaining pumps of the plurality of pumps.

19. The method of claim 16, wherein the plurality of actuators includes:
a left-travel motor;
a right travel motor; and
a linear boom cylinder.

20. The method of claim 19, further including:
selectively connecting a common pump discharge passage with a common pump intake passage at the linear boom cylinder via a regeneration valve; and
limiting fluid flow through the regeneration valve to a single direction.
